(19) United States
(12) Patent Application Publication
(10) Pub. No.: US 2024/0402701 A1
(43) Pub. Date: Dec. 5, 2024

(54) METHOD FOR PREDICTIVE MAINTENANCE THROUGH AUTOMATIC PREDICTION OF PUMP ANOMALY

(71) Applicant: SAMSUNG SDS CO., LTD., Seoul (KR)

(72) Inventors: Sung Bong KIM, Seoul (KR); Yoon Ho JANG, Seoul (KR); Yoon Rock CHOI, Seoul (KR)

(73) Assignee: SAMSUNG SDS CO., LTD., Seoul (KR)

(21) Appl. No.: 18/678,938

(22) Filed: May 30, 2024

(30) Foreign Application Priority Data
May 31, 2023 (KR) 10-2023-0069841

(51) Int. Cl. G05B 23/02; F04B 51/00

(52) U.S. Cl. CPC G05B 23/0283; F04B 51/00

(57) ABSTRACT

A method for predictive maintenance through automatic detection of a pump anomaly is provided. The method according to some embodiments may include receiving a plurality of sensing values of two or more categories, among a plurality of categories, from a plurality of sensors provided in a first pump; inputting a feature representing each of sensing values, selected among the plurality of sensing values, to a first anomaly prediction model that is machine-learned in advance; determining whether a future anomaly of the first pump is predicted to occur, by using data output from the first anomaly prediction model; and providing alarm information based on a determination that the future anomaly is predicted to occur, wherein the first pump belongs to a first pump model group, among a plurality of pump model groups, matched with the first anomaly prediction model.

### CROSS-REFERENCE TO RELATED APPLICATION

This application claims priority from Korean Patent Application No. 10-2023-0069841, filed on May 31, 2023, in the Korean Intellectual Property Office, and all the benefits accruing therefrom under 35 U.S.C. 119, the disclosures of which are herein incorporated in their entireties.

### BACKGROUND

### 1. Technical Field

One or more example embodiments of the present disclosure relate to a method for predictive maintenance through automatic prediction of a pump anomaly, and more particularly, to a method for assisting predictive maintenance before a failure of a pump by automatically predicting an anomaly of a pump equipment and notifying a user of the predicted anomaly of the pump.

### 2. Description of the Related Art

Since semiconductors may react very sensitively to fine dust or particles in a semiconductor manufacturing process, many vacuum pumps capable of maintaining vacuum during a process are provided. In addition, since this pump equipment should operate at high power and constantly maintain a vacuum state, a problem may occur if the pump equipment fails during the semiconductor manufacturing process.

Therefore, a user generally performs predictive maintenance to extend a lifespan of a vacuum pump and prevent sudden interruption of the semiconductor manufacturing process by predicting a failure of the vacuum pump before the vacuum pump is damaged, to replace or repair related parts that may cause a problem.

In the related art method for predictive maintenance of a vacuum pump, since a user performs predictive maintenance using limited data such as data acquired from a vibration sensor of a pump, it is difficult to predict a sudden pump failure and a problem occurs in that a separate sensor and analyzer for sensing the failure should be installed, which increases a cost. Therefore, a method for predictive maintenance of a vacuum pump by analyzing data acquired through various sensors of the vacuum pump is needed.

### SUMMARY

An object of the present disclosure is to provide a method for providing a user with a predictive alarm for a damage of a pump in a semiconductor manufacture line before the pump is damaged.

Another object of the present disclosure is to provide a method for predicting a remaining lifespan of a pump based on a sensing value acquired from a sensor of the pump.

Still another object of the present disclosure is to provide a method for minimizing a false alarm by adjusting anomaly prediction sensitivity based on an anomaly occurrence history of a pump (or a pump model group) and a sensing value of the pump.

Further still another object of the present disclosure is to provide a parameter that can be used as a feature of an anomaly prediction model to improve anomaly prediction performance of the pump in case of anomaly prediction of the pump.

The objects of the present disclosure are not limited to those mentioned above and additional objects of the present disclosure, which are not mentioned herein, will be clearly understood by those skilled in the art from the following description of the present disclosure.

According to an aspect of an example embodiment of the present disclosure, there is provided a method for predictive maintenance through automatic prediction of a pump anomaly, performed by a computing system, the method including: receiving a plurality of sensing values of two or more categories, among a plurality of categories, from a plurality of sensors provided in a first pump, the plurality of categories including a Body Power (BP), a Dry Power (DP), a piping pressure, a temperature, a body temperature, a voltage, a body voltage, and a dry voltage; inputting a feature representing each of sensing values, selected among the plurality of sensing values, to a first anomaly prediction model that is machine-learned in advance; determining whether a future anomaly of the first pump is predicted to occur, by using data output from the first anomaly prediction model; and providing alarm information based on a determination that the future anomaly is predicted to occur, wherein the first pump belongs to a first pump model group, among a plurality of pump model groups, matched with the first anomaly prediction model.

The first pump may be disposed at a first site matched with the first anomaly prediction model, the first site being a specific line, among a plurality of lines, in a factory that performs a semiconductor manufacturing process.

The method may further include predicting an expected lifespan of the first pump by computing a Bayesian probability based on an anomaly occurrence history of the first pump model group and an average lifespan of the first pump model group.

The method may further include: performing principal component analysis (PCA) based on an anomaly occurrence history of the first pump model group and the plurality of sensing values of the first pump; and determining a sensing value of the BP, a sensing value of the DP, and a sensing value of the piping pressure, among the plurality of sensing values, as a sensing value related to an anomaly of the first pump, based on a result of the principal component analysis.

The inputting the feature representing each of sensing values may include: based on a determination that the first pump belongs to the first pump model group, inputting a first feature representing a sensing value of the BP, a second feature representing a sensing value of the DP, and a third feature representing a sensing value of the piping pressure.

The method may further include adjusting prediction sensitivity of the first anomaly prediction model, wherein the adjusting the prediction sensitivity of the first anomaly prediction model includes: upgrading the prediction sensitivity of the first anomaly prediction model through sequential probability ratio verification based on an anomaly occurrence history of the first pump model group and the plurality of sensing values of the first pump; and downgrading the prediction sensitivity of the first anomaly prediction model by adjusting a boundary value of a Poisson filter applied for filtering of a false alarm.

According to an aspect of an example embodiment of the present disclosure, there is provided a method for predictive maintenance through automatic prediction of a pump anomaly, performed by a computing system, the method including: receiving a plurality of sensing values from a plurality of sensors provided in a pump, the plurality of sensing values including a sensing value of a Body Power (BP), a sensing value of a Dry Power (DP), a sensing value of a piping pressure, and a sensing value of a body temperature; inputting a first feature representing the sensing value of the BP, a second feature representing the sensing value of the DP, a third feature representing the sensing value of the piping pressure, and a fourth feature representing the sensing value of the body temperature, to an anomaly prediction model that is machine-learned in advance; determining whether a future anomaly of the pump is predicted to occur, by using data output from the anomaly prediction model; and providing alarm information based on a determination that the future anomaly is predicted to occur, wherein, among a plurality of pump model groups including a first pump model group and a second pump model group, the pump belongs to the second pump model group matched with the anomaly prediction model.

The pump may be disposed at a site matched with the anomaly prediction model, the site being a specific line, among a plurality of lines, in a factory that performs a semiconductor manufacturing process.

The method may further include predicting an expected lifespan of the pump by computing a Bayesian probability based on an anomaly occurrence history of the pump and an average lifespan of the second pump model group.

The method may further include: performing principal component analysis (PCA) based on an anomaly occurrence history of the second pump model group and the plurality of sensing values of the pump; and determining the sensing value of the BP, the sensing value of the DP, the sensing value of the piping pressure, and the sensing value of the body temperature among the plurality of sensing values as a sensing value related to an anomaly of the pump, based on a result of the principal component analysis.

The method may further include adjusting prediction sensitivity of the anomaly prediction model, wherein the adjusting prediction sensitivity of the anomaly prediction model includes: upgrading prediction sensitivity of the anomaly prediction model through sequential probability ratio verification based on an anomaly occurrence history of the second pump model group and the plurality of sensing values of the pump; and downgrading prediction sensitivity of the anomaly prediction model by adjusting a boundary value of a Poisson filter applied for filtering of a false alarm.

According to an aspect of an example embodiment of the present disclosure, there is provided a method for predictive maintenance through automatic prediction of a pump anomaly, performed by a computing system, the method including: receiving a plurality of sensing values from a plurality of sensors provided in a pump, the plurality of sensing values including a sensing value of a voltage, a sensing value of a temperature, and a sensing value of a piping pressure; inputting a first feature representing the sensing value of the voltage, a second feature representing the sensing value of the temperature, and a third feature representing the sensing value of the piping pressure to an anomaly prediction model that is machine-learned in advance; determining whether a future anomaly of the pump is predicted to occur, by using data output from the anomaly prediction model; and providing alarm information based on a determination that the future anomaly is predicted to occur, and wherein, among a plurality of pump model groups including a first pump model group to a third pump model group, the pump belongs to the third pump model group matched with the anomaly prediction model.

The pump may be disposed at a site matched with the anomaly prediction model, the site being a specific line, among a plurality of lines, in a factory that performs a semiconductor manufacturing process.

The method may further include predicting an expected lifespan of the pump by computing a Bayesian probability based on an anomaly occurrence history of the third pump model group and an average lifespan of the third pump model group.

The method may further include: performing principal component analysis (PCA) based on an anomaly occurrence history of the third pump model group and the plurality of sensing values of the pump; and determining the sensing value of the voltage, the sensing value of the temperature, and the sensing value of the piping pressure, among the plurality of sensing values, as a sensing value related to an anomaly of the third pump model group, based on a result of the principal component analysis.

The method may further include adjusting prediction sensitivity of the anomaly prediction model, wherein the adjusting prediction sensitivity of the anomaly prediction model includes: upgrading prediction sensitivity of the anomaly prediction model through sequential probability ratio verification based on an anomaly occurrence history of the third pump model group and the plurality of sensing values of the pump; and downgrading prediction sensitivity of the anomaly prediction model by adjusting a boundary value of a Poisson filter applied for filtering of a false alarm.

According to an aspect of an example embodiment of the present disclosure, there is provided a method for predictive maintenance through automatic prediction of a pump anomaly, performed by a computing system, the method including: receiving a plurality of sensing values from a plurality of sensors provided in a pump, the plurality of sensing values including a sensing value of each of a Body Power (BP), a sensing value of a Dry Power (DP), a sensing value of a body temperature, a sensing value of a body voltage, a sensing value of a dry voltage, and a sensing value of a piping temperature; inputting a first feature representing the sensing value of the BP, a second feature representing the sensing value of the DP, a third feature representing the sensing value of the body temperature, a fourth feature representing the sensing value of the body voltage, a fifth feature representing the sensing value of the dry voltage, and a sixth feature representing the sensing value of the piping temperature to an anomaly prediction model that is machine-learned in advance; determining whether a future anomaly of the pump is predicted to occur, by using data output from the anomaly prediction model; and providing alarm information based on a determination that the future anomaly is predicted to occur, and wherein, among a plurality of pump model groups including a first pump model group to a fourth pump model group, the pump belongs to the fourth pump model group matched with the anomaly prediction model.

The method may further include predicting an expected lifespan of the pump by computing a Bayesian probability based on an anomaly occurrence history of the fourth pump model group and an average lifespan of the fourth pump model group.

The method may further include: performing principal component analysis (PCA) based on an anomaly occurrence history of the fourth pump model group and the plurality of sensing values of the pump; and determining the sensing value of the BP, the sensing value of the DP, the sensing value of the body temperature, the sensing value of the body voltage, the sensing value of the dry voltage, and the sensing value of the piping temperature, among the plurality of sensing values, as a sensing value related to an anomaly of the fourth pump model group, based on a result of the principal component analysis.

The method may further include: adjusting prediction sensitivity of the anomaly prediction model, wherein the adjusting prediction sensitivity of the anomaly prediction model includes: upgrading prediction sensitivity of the anomaly prediction model through sequential probability ratio verification based on an anomaly occurrence history of the fourth pump model group and the plurality of sensing values of the pump; and downgrading prediction sensitivity of the anomaly prediction model by adjusting a boundary value of a Poisson filter applied for filtering of a false alarm.

### BRIEF DESCRIPTION OF THE DRAWINGS

The above and other aspects and features of the present disclosure will become more apparent by describing in detail certain example embodiments thereof with reference to the attached drawings, in which:

FIG. 1 illustrates an example of an environment to which a predictive maintenance system according to an example embodiment of the present disclosure may be applied;

FIG. 2 is a flowchart illustrating a method for predictive maintenance through automatic prediction of a pump anomaly according to an example embodiment of the present disclosure;

FIG. 3 is a view illustrating an operation of determining a target sensing value corresponding to a model of a pump according to some example embodiments of the present disclosure;

FIG. 4 is a view illustrating a sensing value to be input to each anomaly prediction model according to some example embodiments of the present disclosure;

FIG. 5 is a view illustrating an operation of predicting an anomaly of a first pump model, according to some example embodiments of the present disclosure;

FIG. 6 is a view illustrating an operation of predicting an anomaly of a second pump model according to some example embodiments of the present disclosure;

FIG. 7 is a view illustrating an example of a pump anomaly prediction history according to some example embodiments of the present disclosure;

FIG. 8 is a view illustrating an operation of adjusting prediction sensitivity of an anomaly prediction model according to some example embodiments of the present disclosure;

FIG. 9 is a view illustrating an operation of predicting a remaining lifespan of a pump according to some example embodiments of the present disclosure;

FIG. 10 is a view illustrating an operation of predicting a remaining lifespan of a pump according to some example embodiments of the present disclosure; and

FIG. 11 is a schematic view illustrating a configuration of a predictive maintenance system according to an example embodiment of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In describing this disclosure, specific descriptions of relevant disclosed configurations or features are omitted where it is believed that such detailed descriptions would obscure the essence of the invention.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), may be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, the meaning of some terms that may appear in the present disclosure will be clarified before description of some example embodiments of the present disclosure.

A first pump to a fourth pump (or a first type pump to a fourth type pump) according to some example embodiments of the present disclosure may refer to pumps included in different pump model groups, respectively. However, a criterion for grouping the pumps according to some example embodiments of the present disclosure into a specific pump model group is not limited.

For example, the first pump may be any one of a plurality of pumps belonging to a first pump model group.

The first to fourth pumps according to some other example embodiments of the present disclosure may refer to pumps disposed at different sites matched with different anomaly prediction models, respectively. In this case, each site of the different sites may be a specific line for performing a semiconductor manufacturing process, and the specific line may be one of a plurality of lines included in a factory for performing the semiconductor manufacturing process.

For example, the first pump may be disposed at a first site, which is a first line included in a first factory, and the first site may be matched with a first anomaly prediction model. On the other hand, for example, the second pump may be disposed at a second site, which is a first line included in a second factory, and the second site may be matched with a second anomaly prediction model.

For another example, the first pump may be disposed at the first site, which is the first line included in the first factory, and the first site may be matched with the first anomaly prediction model. On the other hand, for example, the second pump may be disposed at a second site, which is a second line included in the first factory, and the second site may be matched with the second anomaly prediction model.

The first to fourth pumps according to some other more example embodiments of the present disclosure may be pumps that belong to different pump model groups and are disposed at different sites matched with different anomaly prediction models.

For example, the first pump may be a pump that belongs to the first pump model group and is disposed at the first site, which is the first line included in the first factory, and thus, the first pump may be matched with the first anomaly prediction model. On the other hand, for example, the second pump may be a pump that belongs to the second pump model group and is disposed at the first site, which is the first line included in the first factory, and in this case, the second pump may be matched with the second anomaly prediction model.

In order to predict the anomaly of the pump through the anomaly prediction model, data of various categories sensed from a sensor of the pump may be used; however, even if the same anomaly prediction model is applied to the first pump and the second pump of the same model disposed at the first site and the second site, respectively, prediction performance or prediction reliability represents different results. Therefore, the method for predictive maintenance through automatic prediction of a pump anomaly according to the present disclosure may consider both the site where the pump is disposed and a model type matched with the pump (or the model group to which the pump belongs), thereby providing a method for predicting a pump anomaly having improved reliability and performance than the related art method for predicting a pump anomaly.

Hereinafter, some example embodiments of the present disclosure will be described with reference to the drawings.

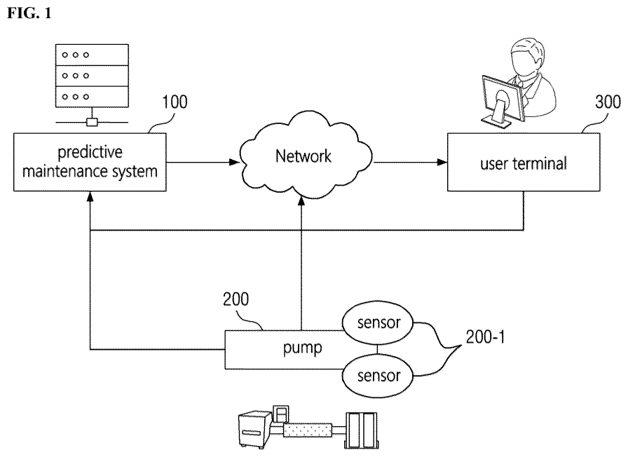

FIG. 1 illustrates an example of an environment to which a predictive maintenance system according to an example embodiment of the present disclosure may be applied.

A predictive maintenance system 100 according to an example embodiment of the present disclosure may receive data sensed from one or more sensors 200-1 of a pump 200.

In some embodiments of the present disclosure, the predictive maintenance system 100 may receive data of Body Power (BP), data of Dry Power (DP), and data of piping pressure from the pump 200 based on a determination that the pump 200 is a first type pump.

In some other embodiments of the present disclosure, the predictive maintenance system 100 may receive data of BP, data of DP, data of piping pressure, and data of body temperature from the pump 200 based on a determination that the pump 200 is a second type pump.

In some other embodiments of the present disclosure, the predictive maintenance system 100 may receive data of voltage, data of temperature, and data of piping pressure from the pump 200 based on a determination that the pump 200 is a third type pump.

In some other embodiments of the present disclosure, the predictive maintenance system 100 may receive data of BP, data of DP, data of body temperature, data of body voltage, data of dry voltage, and data of piping temperature from the pump 200 based on a determination that the pump 200 is a fourth type pump.

In some other embodiments of the present disclosure, the first to fourth type pumps may be classified in accordance with manufacturer information or a model name of the pumps, but the present disclosure is not limited thereto.

The predictive maintenance system 100 according to an example embodiment of the present disclosure may input the data received from the pump 200 to an anomaly prediction model corresponding to the pump, determine whether a future anomaly of the pump 200 is predicted to occur based on output data of the anomaly prediction model, and output an alarm signal or transmit the alarm signal to a user terminal 300 when it is determined that the future anomaly is predicted to occur.

For example, the predictive maintenance system 100 may input the data received from the pump 200, which is stored in a personal communication service (PCS) system 23, to the anomaly prediction model, and may alarm an anomaly of the pump 200 to a field personnel of a semiconductor manufacture line by using the output of the anomaly prediction model 22.

Therefore, the predictive maintenance system 100 according to the present embodiment may predict an anomaly of the pump 200 by using the data received from the pump 200 and alarm a field personnel of the predicted anomaly, and the field personnel who identifies the alarm may prevent and maintain the pump 200 before the pump 200 is damaged.

The anomaly prediction model according to some embodiments of the present disclosure may select a sensing value related to a failure of the pump 200, among sensing values of a plurality of categories sensed from the sensor(s) 200-1 of the pump 200, based on the sensing value of the pump 200, which is stored in the PCS system 23, and breakdown maintenance (BM) history information of the pump 200, which will be described in detail later.

The pump 200 according to an example embodiment of the present disclosure may be disposed in a semiconductor manufacture line.

The pump 200 according to an example embodiment of the present disclosure may transmit at least a portion of the sensing value of the pump 200 to the predictive maintenance system 100.

As described above, an example of an environment to which the predictive maintenance system 100 according to an example embodiment of the present disclosure may be applied and operations of components included in the environment have been described in detail with reference to FIG. 1. The operation of the predictive maintenance system 100 according to an example embodiment of the present disclosure will be understood in more detail with reference to example embodiments that will be described later. In addition, the technical spirits that may be understood through the above-described embodiment of the predictive maintenance system 100 may be reflected in the example embodiments that will be described later although not specified separately.

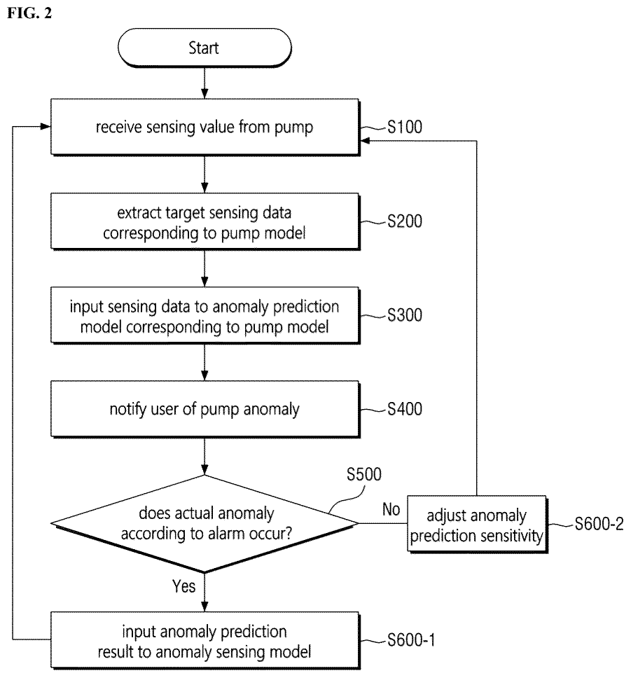

Hereinafter, a method for predictive maintenance through automatic prediction of a pump anomaly according to one or more example embodiments of the present disclosure will be described in detail with reference to FIGS. 2 to 10. Hereinafter, it may be understood that some operations to be described with reference to some flowcharts may be performed by the predictive maintenance system 100 described with reference to FIG. 1 unless otherwise declared.

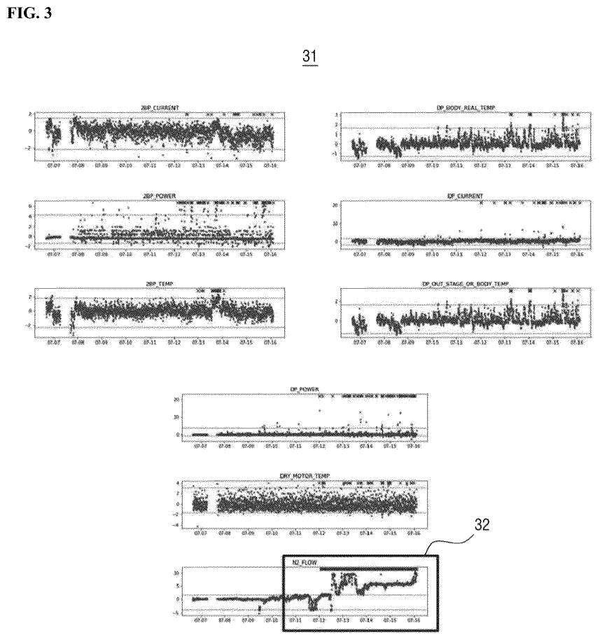

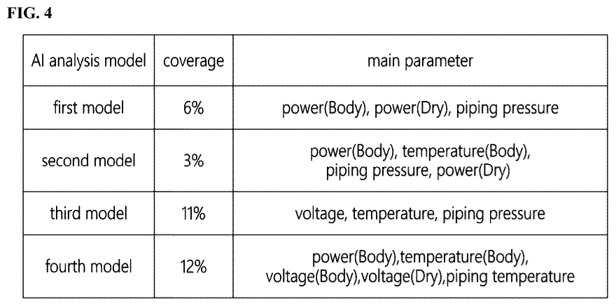

FIG. 2 is a flowchart illustrating a method for predictive maintenance through automatic prediction of a pump anomaly according to an example embodiment of the present disclosure. FIG. 3 is a view illustrating an operation of determining a target sensing value corresponding to a model of a pump according to some example embodiments of the present disclosure. FIG. 4 is a view illustrating a sensing value to be input to each anomaly prediction model according to some example embodiments of the present disclosure. Hereinafter for brevity of description, the term “model of the pump” or “pump model” may be used to refer to a pump model group to which the pump belongs.

In operation S100 shown in FIG. 2, the predictive maintenance system 100 may receive the sensing value from the sensor 200-1 of the pump 200.

For example, as shown in FIG. 3, the predictive maintenance system 100 may receive sensing values 31 of the pump 200, which include sensing values of a plurality of categories such as data of BP, data of DP, data of voltage, and data of N2 flow rate 32, from the sensor 200-1 of the pump 200.

In operation S200, the predictive maintenance system 100 may extract a target sensing value corresponding to the model of the pump 200.

In some embodiments related to operation S200, the predictive maintenance system 100 may determine data related to an anomaly of the pump 200 among the sensing values of the plurality of categories received from the pump 200.

In some other embodiments related to operation S200, for example, referring to FIG. 3, the pump 200 may be a first pump model, and the predictive maintenance system 100 may determine N2 flow rate data 32 as data related to a failure of the first pump model based on one or more sensing values associated with the first pump model and an anomaly occurrence history of the first pump model.

In some other embodiments related to operation S200, referring to FIG. 3, the predictive maintenance system 100 may perform principal component analysis (PCA) based on the one or more sensing values associated with the first pump model and the anomaly occurrence history of the first pump model and determine the data of the N2 flow rate 32 as data related to the anomaly of the first pump model as a result of the analysis.

In some other embodiments related to operation S200, the predictive maintenance system 100 may extract only the N2 flow data from the received sensing value in accordance with the determination that the pump that receives the sensing values 31 is the first pump model.

In operation S300, the predictive maintenance system 100 may input the extracted target sensing value to the anomaly prediction model corresponding to the first pump model.

In some embodiments related to operation S300, referring to FIG. 4, when the pump 200 is the first pump model, the predictive maintenance system 100 may input the data of body power (BP), the data of dry power (DP), and the data of piping pressure, which are received from the first pump model, to the first anomaly prediction model matched with the first pump model.

In some other embodiments related to operation S300, referring to FIG. 4, when the pump 200 is a second pump model, the predictive maintenance system 100 may input the data of BP, the data of DP, the data of piping pressure, and the data of body temperature, which are received from the second pump model, to the second anomaly prediction model matched with the second pump model.

In some other embodiments related to operation S300, referring to FIG. 4, when the pump 200 is a third pump model, the predictive maintenance system 100 may input the data of voltage, the data of temperature, and the data of piping pressure, which are received from the third pump model, to the third anomaly prediction model matched with the third pump model.

In some other embodiments related to operation S300, referring to FIG. 4, when the pump 200 is the fourth pump model, the predictive maintenance system 100 may input the data of BP, the data of DP, the data of body temperature, the data of body voltage, the data of dry voltage, and the data of piping temperature, which are received from the fourth pump model, to the fourth anomaly prediction model matched with the fourth pump model.

In some other embodiments related to operation S300, the predictive maintenance system 100 may input a sensing value of each of BP, DP and piping pressure among the sensing values received from the first pump model to the first anomaly prediction model, and may determine whether a future anomaly of the first pump model is predicted to occur, based on output data of the first anomaly prediction model.

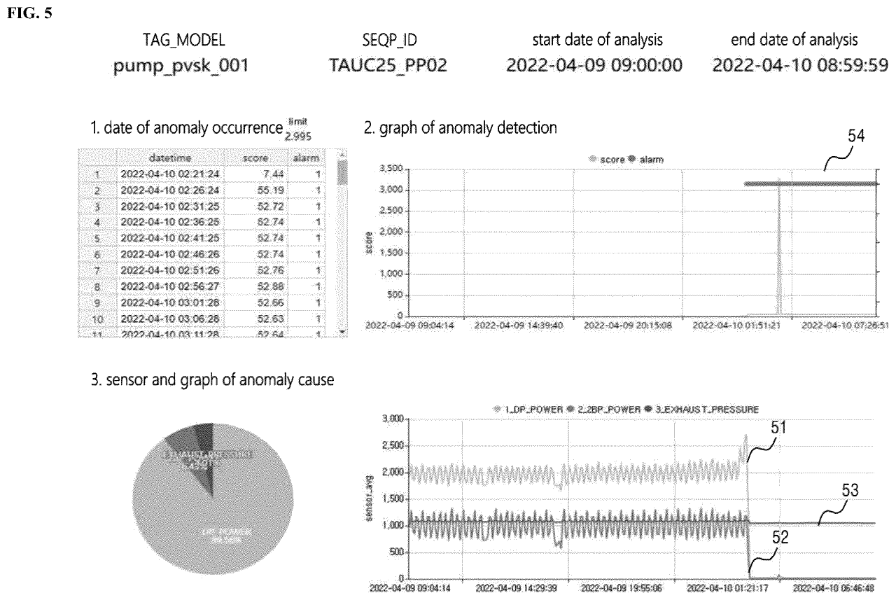

FIG. 5 is a view illustrating an operation of predicting an anomaly of a first pump model, according to some example embodiments of the present disclosure. For example, referring to FIG. 5, the predictive maintenance system 100 may input a sensing value of each of a DP 51, a BP 52, and a piping pressure 53 among the sensing values received from the first pump model to the first anomaly prediction model. As the DP 51 and the BP 52 of the first pump model are reduced by a reference value or more within a predefined time, the first anomaly prediction model may output a future anomaly occurrence score 54 of the first pump model, and the predictive maintenance system 100 may determine whether a future anomaly of the first pump model is predicted to occur, based on data of the future anomaly occurrence score 54 of the first pump model.

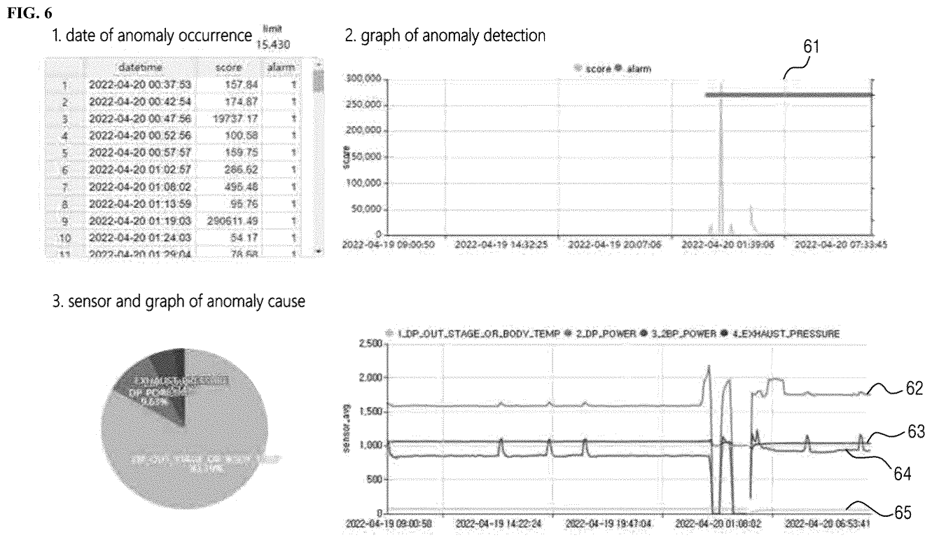

FIG. 6 is a view illustrating an operation of predicting an anomaly of a second pump model according to some example embodiments of the present disclosure. Referring to FIG. 6, the predictive maintenance system 100 receives sensing values from the pump, and inputs only a sensing value of each of a DP 62, a piping pressure 63, a BP 64, and a body temperature 65, among the received sensing values, to the second anomaly prediction model in accordance with the determination that the pump is the second pump model that matches with the second anomaly prediction model. As the BP 64 and the DP 62 of the second pump model are changed by a reference value or more within a predefined time, the second anomaly prediction model may output a future anomaly occurrence score 61 of the second pump model, and the predictive maintenance system 100 may determine whether a future anomaly of the second pump model is predicted to occur, based on data of the future anomaly occurrence score 61 of the second pump model.

However, the above-described operation of outputting the future anomaly occurrence score by the first and second anomaly prediction models based on an amount of a change in sensing data of the first and second pump models is only an example embodiment of the present disclosure. The anomaly prediction models may be black box models learned based on the anomaly occurrence history of the pump and the sensing data of the pump, and it should be understood that a method of determining the reference value and a method of outputting the future anomaly occurrence score are not limited.

Referring back to FIG. 2, in operation S400, the predictive maintenance system 100 may output an alarm signal for an anomaly of the pump, based on a determination as a result of operation S300 that a future anomaly of the pump is predicted to occur.

In some embodiments related to operation S400, the predictive maintenance system 100 may identify the anomaly of the pump, which is determined in accordance with the result of operation S300, and display alarm information on a display device included in or connected to the predictive maintenance system 100. The alarm information may be provided by various visual and/or non-visual methods using, for example, a display device, an audio output device such as a speaker, and/or a haptic device using vibrations, tactile sensation, and the like. The alarm information may include an identifier of the pump determined to have a predicted future anomaly and information on the predicted future anomaly.

In some embodiments related to operation S400, the predictive maintenance system 100 may transmit data on the predicted anomaly of the pump, which is determined in accordance with the result of operation S300, to the user terminal 300, and the user terminal 300 may output the alarm information (e.g., alarm signal) upon receiving the data on the predicted anomaly of the pump.

The predictive maintenance system of the related art has a problem that the pump's anomaly prediction success rate is very low because the related art method for predicting the pump's anomaly is based on one sensing value received from the pump even though a number of different pumps are disposed on one semiconductor manufacture line.

The predictive maintenance system 100 according to an example embodiment may not only have different parameters (or sensing values) referenced to predict an anomaly for each pump model but may also reference a plurality of parameters (or sensing values) even for one pump model, thereby improving the pump's anomaly prediction success rate as compared with the related art method for predictive maintenance.

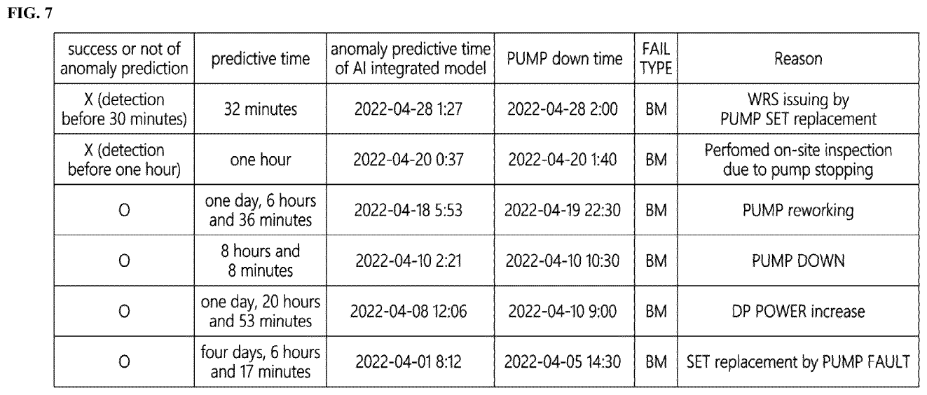

FIG. 7 is a view illustrating an example of a pump anomaly prediction history according to some example embodiments of the present disclosure. Referring to a table of FIG. 7, the predictive maintenance system 100 according to an example embodiment may achieve an anomaly prediction success rate of 67% or more (four success out of six anomaly predictions) even though outputting an anomaly prediction alarm signal within 2 hours that would still allow some time to take action for the anomaly of the pump is regarded as an anomaly prediction failure.

Referring back to FIG. 2, in operation S500, a user may identify the alarm signal (or alarm information) of the predictive maintenance system 100 and determine whether an actual anomaly has occurred in the pump corresponding to the alarm signal.

When it is determined that the actual anomaly of the pump corresponding to the alarm signal output by the predictive maintenance system 100 has not occurred (‘No’ at S500), in operation S600-2, the user may adjust anomaly prediction sensitivity of the anomaly prediction model corresponding to the pump.

In some embodiments related to operation S600-2, the user may adjust the anomaly prediction sensitivity of the anomaly prediction model corresponding to the pump in accordance with the determination that an actual anomaly of the pump has occurred but the predictive maintenance system 100 has not output a future anomaly occurrence alarm for the pump.

In some embodiments related to operation S600-2, the prediction sensitivity of the anomaly prediction model may be upgraded (e.g., increased) through sequential probability ratio verification based on the anomaly occurrence history of the pump and the sensing value of the pump.

In some embodiments related to operation S600-2, the prediction sensitivity of the anomaly prediction model may be downgraded (e.g., decreased) by adjusting a boundary value of a Poisson filter applied to output the alarm signal.

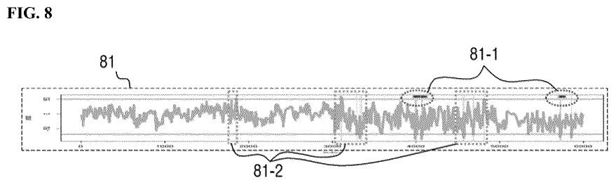

FIG. 8 is a view illustrating an operation of adjusting prediction sensitivity of an anomaly prediction model according to some example embodiments of the present disclosure. In some embodiments related to operation S600-2, referring to a sensing value graph 81 of a feature corresponding to the first pump model in FIG. 8, the user may adjust prediction sensitivity of the anomaly prediction model such that a false alarm 81-2 of the first pump model may not be actually output, and only a true alarm 81-1 may be output.

In operation S600-1, the predictive maintenance system 100 may train the anomaly prediction model by inputting the anomaly prediction result to the anomaly prediction model in accordance with a user feedback that the actual anomaly of the pump according to the anomaly prediction alarm has occurred.

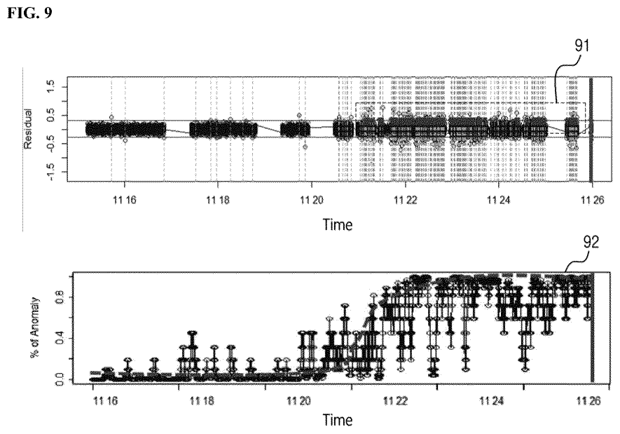

FIG. 9 is a view illustrating an operation of predicting a remaining lifespan of a pump according to some example embodiments of the present disclosure. In some embodiments related to operation S600-1, referring to FIG. 9, the predictive maintenance system 100 may predict a remaining lifespan of the first pump model in accordance with an anomaly occurrence history 91 of the first pump, the sensing value of the first pump model, and average lifespan information 92 of the first pump model.

In some embodiments related to operation S600-1, referring to FIG. 9, the predictive maintenance system 100 may predict the remaining lifespan of the first pump model by computing a Bayesian probability based on the anomaly occurrence history 91 of the first pump and the average lifespan information 92 of the first pump model. However, a pump anomaly type included in the anomaly occurrence history 91 of the first pump, which corresponds to a prior probability used for computation of the Bayesian probability, is not limited to any one of anomalies that may occur in the first pump model in the present disclosure.

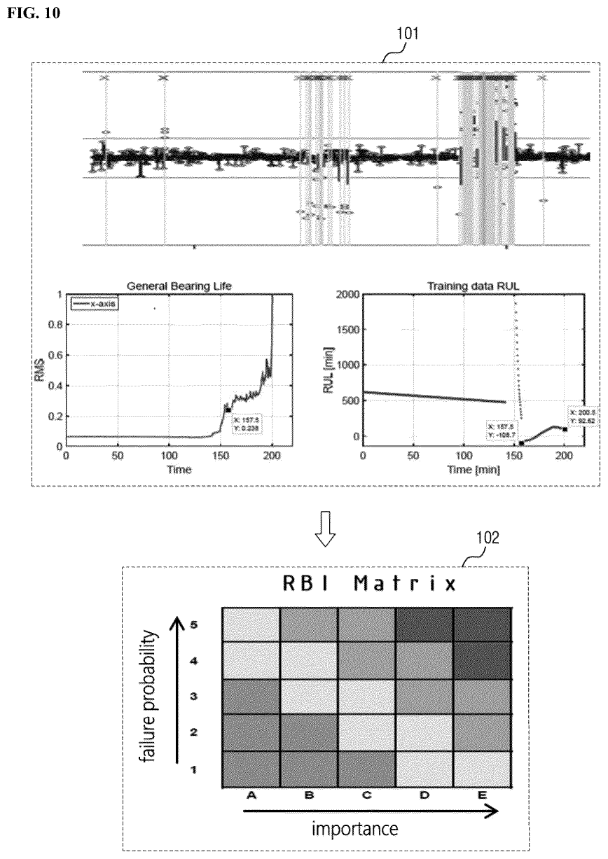

FIG. 10 is a view illustrating an operation of predicting a remaining lifespan of a pump according to some example embodiments of the present disclosure. In some embodiments related to operation S600-1, referring to FIG. 10, the predictive maintenance system 100 may configure a risk-based inspection (RBI) matrix 102 in accordance with a data set 101 of the first pump model. In this case, the data set 101 of the first pump model may include the sensing value of the first pump model, the anomaly occurrence history of the first pump model, and the average lifespan information (e.g., remaining useful life (RUL)) of the first pump model.

In some other embodiments related to operation S600-1, the predictive maintenance system 100 may configure a maintenance schedule for the first pump model based on the RBI matrix 102 of the first pump model. The maintenance schedule of the first pump model may be configured by the following equation.

$$Maximize {\sum }_{t = 1}^{T} {\sum }_{c = 1}^{C} {W}_{C} * Rc * Xtc$$

In this case, T may mean a specific time area, W_{C} may mean an importance weight for each equipment, Rc may mean a weight for a failure risk for each equipment, and Xtc may mean whether to determine maintenance of the first pump model.

The method for predictive maintenance through automatic prediction of a pump anomaly according to one or more example embodiments of the present disclosure has been described in detail with reference to FIGS. 2 to 10. It should be understood that the above-described embodiments are to be considered in all respects as illustrative and not restrictive.

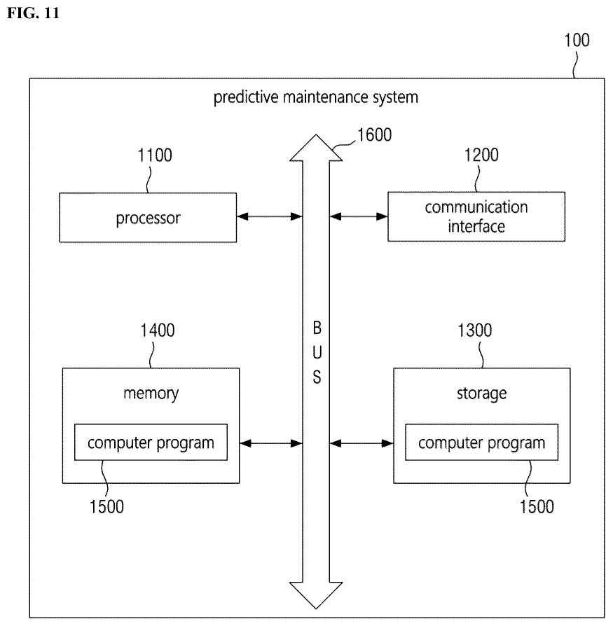

FIG. 11 is a schematic view illustrating a configuration of a predictive maintenance system 100. The predictive maintenance system 100 in FIG. 11 may be the predictive maintenance system 100 described with reference to FIG. 1. Referring to FIG. 11, the predictive maintenance system 100 may include at least one processor 1100, a system bus 1600, a communication interface 1200, a memory 1400, which loads a computer program 1500 to be executed by the processor 1100, and a storage 1300, which stores the computer program 1500.

The processor 1100 may control the overall operations of the components of the predictive maintenance system 100. The processor 1100 may perform computations for at least one application or program for executing operation(s) and/or method(s) according to some embodiments of the present disclosure. The memory 1400 may store various data, commands, and/or information. The memory 1400 may load the computer program 1500 from the storage 1300 to execute the operation(s) and/or method(s) according to some embodiments of the present disclosure. The memory 1400 may be implemented as a volatile memory such as a random access memory (RAM), but the present disclosure is not limited thereto.

The bus 1600 may provide communication functionally among the components of the predictive maintenance system 100. The communication interface 1200 may support both wired and wireless Internet communication for the predictive maintenance system 100. The storage 1300 may temporarily store at least one computer program 1500. The computer program 1500 may include one or more instructions that, upon being loaded into the memory 1400, cause the processor 1100 to perform the operation(s) and/or method(s) according to some embodiments of the present disclosure. In other words, by executing the loaded instructions, the processor 1100 may perform the operation(s) and/or method(s) according to some embodiments of the present disclosure.

In some embodiments, the predictive maintenance system 100 may refer to a virtual machine implemented based on cloud technology. For example, the predictive maintenance system 100 may be a virtual machine operating on one or more physical servers within a server farm. In this example, at least some of the components of the predictive maintenance system 100, e.g., the processor 1100, the memory 1400, and the storage 1300, may be implemented as virtual hardware, and the communication interface 1200 may be implemented as a virtual networking element such as a virtual switch.

The computer program 1500 may include instructions that, when executed on the predictive maintenance system 100, perform the operations of: receiving a sensing value from a plurality of sensors provided in a first pump, the sensing value including a sensing value of, for example, each of a Body Power (BP), a Dry Power (DP) and a piping pressure; inputting a first feature representing the sensing value of the BP, a second feature representing the sensing value of the DP and a third feature representing the sensing value of the piping pressure to a first anomaly prediction model that is machine-learned in advance; determining whether a future anomaly of the first pump is predicted to occur, by using data output from the first anomaly prediction model; and outputting alarm information (e.g., displaying an alarm signal) on a screen when it is determined that a future anomaly is predicted to occur.

Various example embodiments of the present disclosure and their effects have been described with reference to FIGS. 1 to 11. However, the technical concepts of the present disclosure are not limited to the effects set forth herein, and other effects not explicitly mentioned may be readily understood by those skilled in the art to which the present disclosure, from the provided description below.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results may be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

What is claimed is:

1. A method for predictive maintenance through automatic prediction of a pump anomaly, performed by a computing system, the method comprising:
receiving a plurality of sensing values of two or more categories, among a plurality of categories, from a plurality of sensors provided in a first pump, the plurality of categories including a Body Power (BP), a Dry Power (DP), a piping pressure, a temperature, a body temperature, a voltage, a body voltage, and a dry voltage;
inputting a feature representing each of sensing values, selected among the plurality of sensing values, to a first anomaly prediction model that is machine-learned in advance;
determining whether a future anomaly of the first pump is predicted to occur, by using data output from the first anomaly prediction model; and
providing alarm information based on a determination that the future anomaly is predicted to occur,
wherein the first pump belongs to a first pump model group, among a plurality of pump model groups, matched with the first anomaly prediction model.

2. The method of claim 1, wherein the first pump is disposed at a first site matched with the first anomaly prediction model.

3. The method of claim 2, wherein the first site is a specific line, among a plurality of lines, in a factory that performs a semiconductor manufacturing process.

4. The method of claim 1, further comprising predicting an expected lifespan of the first pump by computing a Bayesian probability based on an anomaly occurrence history of the first pump and an average lifespan of the first pump model group.

5. The method of claim 1, further comprising:
performing principal component analysis (PCA) based on an anomaly occurrence history of the first pump and the plurality of sensing values of the first pump; and
determining a sensing value of the BP, a sensing value of the DP, and a sensing value of the piping pressure, among the plurality of sensing values, as a sensing value related to an anomaly of the first pump, based on a result of the principal component analysis.

6. The method of claim 1, wherein the inputting the feature representing each of sensing values comprises:
based on a determination that the first pump belongs to the first pump model group, inputting a first feature representing a sensing value of the BP, a second feature representing a sensing value of the DP, and a third feature representing a sensing value of the piping pressure.

7. The method of claim 1, further comprising adjusting prediction sensitivity of the first anomaly prediction model, wherein the adjusting the prediction sensitivity of the first anomaly prediction model includes:
upgrading the prediction sensitivity of the first anomaly prediction model through sequential probability ratio verification based on an anomaly occurrence history of the first pump and the plurality of sensing values of the first pump; and
downgrading the prediction sensitivity of the first anomaly prediction model by adjusting a boundary value of a Poisson filter applied for filtering of a false alarm.

8. A method for predictive maintenance through automatic prediction of a pump anomaly, performed by a computing system, the method comprising:
receiving a plurality of sensing values from a plurality of sensors provided in a pump, the plurality of sensing values including a sensing value of a Body Power (BP), a sensing value of a Dry Power (DP), a sensing value of a piping pressure, and a sensing value of a body temperature;
inputting a first feature representing the sensing value of the BP, a second feature representing the sensing value of the DP, a third feature representing the sensing value of the piping pressure, and a fourth feature representing the sensing value of the body temperature, to an anomaly prediction model that is machine-learned in advance;
determining whether a future anomaly of the pump is predicted to occur, by using data output from the anomaly prediction model; and
providing alarm information based on a determination that the future anomaly is predicted to occur,
wherein, among a plurality of pump model groups including a first pump model group and a second pump model group, the pump belongs to the second pump model group matched with the anomaly prediction model.

9. The method of claim 8, wherein the pump is disposed at a site matched with the anomaly prediction model.

10. The method of claim 8, further comprising predicting an expected lifespan of the pump by computing a Bayesian probability based on an anomaly occurrence history of the pump and an average lifespan of the second pump model group.

11. The method of claim 9, wherein the site is a specific line among a plurality of lines, in a factory that performs a semiconductor manufacturing process.

12. The method of claim 8, further comprising:
performing principal component analysis (PCA) based on an anomaly occurrence history of the pump and the plurality of sensing values of the pump; and
determining the sensing value of the BP, the sensing value of the DP, the sensing value of the piping pressure, and the sensing value of the body temperature among the plurality of sensing values as a sensing value related to an anomaly of the pump, based on a result of the principal component analysis.

13. The method of claim 8, further comprising adjusting prediction sensitivity of the anomaly prediction model, wherein the adjusting prediction sensitivity of the anomaly prediction model includes:
upgrading prediction sensitivity of the anomaly prediction model through sequential probability ratio verification based on an anomaly occurrence history of the pump and the plurality of sensing values of the pump; and
downgrading prediction sensitivity of the anomaly prediction model by adjusting a boundary value of a Poisson filter applied for filtering of a false alarm.

14. A method for predictive maintenance through automatic prediction of a pump anomaly, performed by a computing system, the method comprising:
receiving a plurality of sensing values from a plurality of sensors provided in a pump, the plurality of sensing values including a sensing value of a voltage, a sensing value of a temperature, and a sensing value of a piping pressure;
inputting a first feature representing the sensing value of the voltage, a second feature representing the sensing value of the temperature, and a third feature representing the sensing value of the piping pressure to an anomaly prediction model that is machine-learned in advance;
determining whether a future anomaly of the pump is predicted to occur, by using data output from the anomaly prediction model; and
providing alarm information based on a determination that the future anomaly is predicted to occur, and
wherein, among a plurality of pump model groups including a first pump model group to a third pump model group, the pump belongs to the third pump model group matched with the anomaly prediction model.

15. The method of claim 14, wherein the pump is disposed at a site matched with the anomaly prediction model.

16. The method of claim 14, further comprising predicting an expected lifespan of the pump by computing a Bayesian probability based on an anomaly occurrence history of the pump and an average lifespan of the third pump model group.

17. The method of claim 15, wherein the site is a specific line among a plurality of lines, in a factory that performs a semiconductor manufacturing process.

18. The method of claim 14, further comprising:
performing principal component analysis (PCA) based on an anomaly occurrence history of the pump and the plurality of sensing values of the pump; and
determining the sensing value of the voltage, the sensing value of the temperature, and the sensing value of the piping pressure, among the plurality of sensing values, as a sensing value related to an anomaly of the third pump model group, based on a result of the principal component analysis.

19. The method of claim 14, further comprising adjusting prediction sensitivity of the anomaly prediction model, wherein the adjusting prediction sensitivity of the anomaly prediction model includes:
upgrading prediction sensitivity of the anomaly prediction model through sequential probability ratio verification based on an anomaly occurrence history of the pump and the plurality of sensing values of the pump; and
downgrading prediction sensitivity of the anomaly prediction model by adjusting a boundary value of a Poisson filter applied for filtering of a false alarm.

20. A method for predictive maintenance through automatic prediction of a pump anomaly, performed by a computing system, the method comprising:
receiving a plurality of sensing values from a plurality of sensors provided in a pump, the plurality of sensing values including a sensing value of each of a Body Power (BP), a sensing value of a Dry Power (DP), a sensing value of a body temperature, a sensing value of a body voltage, a sensing value of a dry voltage, and a sensing value of a piping temperature;
inputting a first feature representing the sensing value of the BP, a second feature representing the sensing value of the DP, a third feature representing the sensing value of the body temperature, a fourth feature representing the sensing value of the body voltage, a fifth feature representing the sensing value of the dry voltage, and a sixth feature representing the sensing value of the piping temperature to an anomaly prediction model that is machine-learned in advance;
determining whether a future anomaly of the pump is predicted to occur, by using data output from the anomaly prediction model; and
providing alarm information based on a determination that the future anomaly is predicted to occur, and
wherein, among a plurality of pump model groups including a first pump model group to a fourth pump model group, the pump belongs to the fourth pump model group matched with the anomaly prediction model.

21. The method of claim 20, further comprising predicting an expected lifespan of the pump by computing a Bayesian probability based on an anomaly occurrence history of the pump and an average lifespan of the fourth pump model group.

22. The method of claim 20, wherein the pump is disposed at a site matched with the anomaly prediction model.

23. The method of claim 22, wherein the site is a specific line among a plurality of lines, in a factory that performs a semiconductor manufacturing process.

24. The method of claim 20, further comprising:
performing principal component analysis (PCA) based on an anomaly occurrence history of the pump and the plurality of sensing values of the pump; and
determining the sensing value of the BP, the sensing value of the DP, the sensing value of the body temperature, the sensing value of the body voltage, the sensing value of the dry voltage, and the sensing value of the piping temperature, among the plurality of sensing values, as a sensing value related to an anomaly of the fourth pump model group, based on a result of the principal component analysis.

25. The method of claim 20, further comprising adjusting prediction sensitivity of the anomaly prediction model, wherein the adjusting prediction sensitivity of the anomaly prediction model includes:
upgrading prediction sensitivity of the anomaly prediction model through sequential probability ratio verification based on an anomaly occurrence history of the fourth pump model group and the plurality of sensing values of the pump; and
downgrading prediction sensitivity of the anomaly prediction model by adjusting a boundary value of a Poisson filter applied for filtering of a false alarm.
